(19) United States
(12) Patent Application Publication
(10) Pub. No.: US 2002/0087224 A1
(43) Pub. Date: Jul. 4, 2002

(54) Concatenated audio title

(76) Inventor: Steven E. Barile, Portland, OR (US)

Correspondence Address: Charles A. Mirho, BLAKELY, SOKOLOFF, TAYLOR & ZAFMAN, LLP, 7th Floor, 124000 Wilshire Boulevard, Los Angeles, CA, 90025, US

(21) Appl. No.: 09/752,611

(22) Filed: Dec. 29, 2000

(51) Int. Cl. G06F 17/00; G06F 15/16

(52) U.S. Cl. 700/94; 709/200; 381/58

(57) ABSTRACT

A method includes reading descriptive information about an audio file from meta-data for the audio file, and concatenating at least a portion of an audio format of the descriptive information to the audio file.

### BACKGROUND

1. Field

The present invention relates generally to digital audio and, more specifically, to digital audio player applications.

2. Description

Audio players that render digital audio files for listening by a user are popular these days. Several different digital audio data formats are in common use, with the most common being the Motion Picture Expert Group (MPEG) audio layer 3 or “MP3” format. When digital audio data is stored in a file in the well-known MP3 format, the file may be easily moved, copied, transferred, and rendered by an audio player device. Such devices include personal and laptop computers, hand-held computing devices, set-top boxes, and portable MP3 players, to name just a few. Of course, MP3 is just one example of a digital audio format, and many others can and do exist.

Some digital audio formats, such as the MP3 format, include meta-data (data which describes the audio data of the file). The meta-data may be stored along with the audio content in a single audio file. Meta-data can include such information as the song title, a description of the song (e.g., what it is meant to portray), bibliographic information about the artists, the length of the song, and much more. Even when the file format does not include meta-data, the meta-data for the file is often accessible (perhaps in another, separate file or files) from the location where the file is stored.

In one common scenario, a user downloads an audio file from a storage location on a network, such as an Internet site, and stores the file on a personal computer or other Internet-access device. The user may then play (render) the audio title using a player application, such as such as Windows Media Player (available from Microsoft Corporation), RealPlayer (available from RealNetworks, Inc.), or WinAmp (available from NullSoft Corporation). The rendered audio is experienced by the user by way of speakers coupled to the personal computer system or other Internet-access device. The meta-data, which in the MP3 format is stored after the audio data (e.g. at the end of the file), is not rendered by the player. Rather, it is used to update display information on a display device of the computer, such as a monitor or liquid crystal display (LCD) screen. Thus, while the audio is rendered from the file, the file's meta-data in textual format, such as title, description, bibliographic information, and more may be displayed on the display device.

In another common scenario, a user copies a digital song from a compact disk (CD) or other distribution media where the file is stored. The copy may be made by inserting the CD into a personal computer (or laptop computer, etc.) from which the song content may be copied and stored into a file, such as an MP3 file, on the computer's hard disk. Upon saving the file, the user may be prompted to provide the song's meta-data. Alternately, the meta-data may be downloaded from a storage location on a network, such as the Internet. The file may be stored in a format, such as MP3, which includes the meta-data.

One disadvantage of the current state of the art is that the meta-data is typically available in a display-compatible format, but not an audio compatible format. In other words, the meta-data often comprises text or other data types which display well, but don't play well (or at all) on speakers. Thus, in order to learn details about the content of an audio file, the user must either play the audio file (to know what song it is), or read the meta-data from a display device. This is dis-advantageous to sight-challenged users. Further, the devices which store and render digital audio files (such as portable MP3 players) may necessarily include displays, which can add to the cost and size of the devices.

Thus, there are opportunities for providing additional capabilities in digital audio applications that overcome these and other disadvantages of the prior art.

### BRIEF DESCRIPTION OF THE DRAWINGS

The features and advantages of the present invention will become apparent from the following detailed description of the present invention in which:

FIG. 1 is a diagram of a system according to an embodiment of the present invention; and

FIG. 2 is a diagram of meta-data according to an embodiment of the present invention.

### DETAILED DESCRIPTION

The present invention provides for the automated concatenation of an audio title to an audio file. The audio title may be generated by applying text-to-speech (TTS) processing to descriptive meta-data for the file. The concatenation may occur as a result of an operation to transmit the file between computer systems. Advantageously, the format of the audio file may be essentially unchanged by the concatenation, so that it remains compatible with existing devices and software for rendering audio files. Further, the audio file may be stored on a first computer system without the concatenated audio title, so that the concatenated version may be generated and transmitted to the computer system of only to those users who may request it.

For example, a user may use a portable MP3 player to render audio files. The user may store MP3 files having song audio content and meta-data on their personal computer. As a result of transmitting the MP3 files from the personal computer to their portable MP3 player (perhaps so that they can travel with their favorite songs), audio titles may be concatenated to the MP3 files. The audio titles may be generated by applying TTS processing to descriptive text (such as the song title) of the file's meta-data. The portable MP3 player stores the files with concatenated audio title. The user may then browse and select the files for rendering by listening to the audio titles, without resort to a visual display of the meta-data. On the personal computer, the files may be stored in their original format, e.g. without the concatenated audio title. Thus the audio files may be available in the original format, without audio titles, for users who prefer the original format.

Herein, references to the term “title” do not necessarily refer strictly to the official title of a song or other content. Rather, the term “title” should be understood to refer to any descriptive information which can provide the user with a better understanding of the nature of the content of a file.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” or “in an embodiment” appearing in various places throughout the specification are not necessarily all referring to the same embodiment.

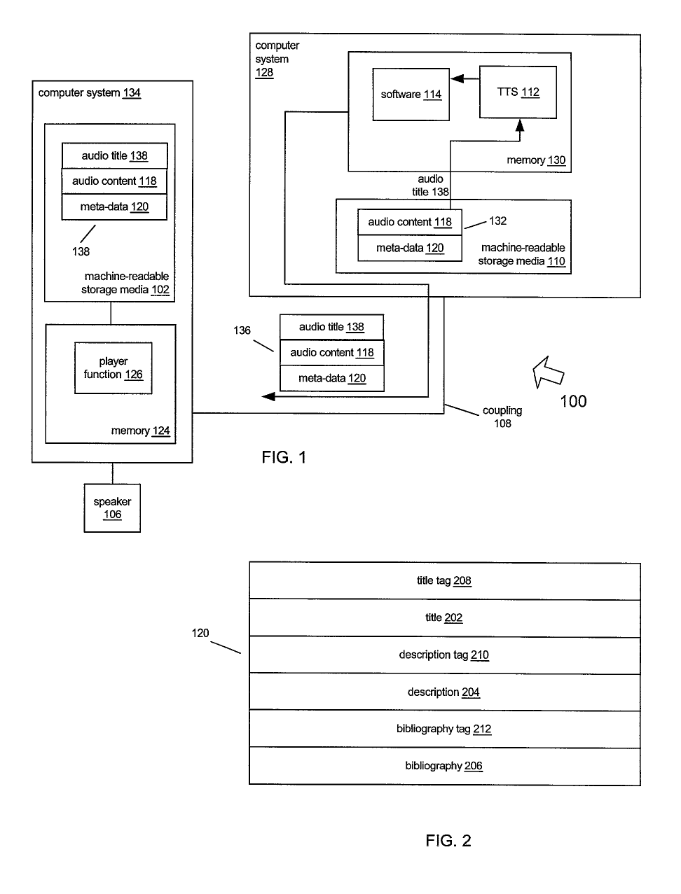

FIG. 1 is a diagram of a system 100 according to an embodiment of the present invention. The system 100 comprises a first computer system 128 having memory 130. A computer system is any device comprising a processor and memory, the memory to store instructions and data which may be applied to the processor. In one embodiment, the computer system 128 comprises at least one of a PC, an Internet or network appliance, a set-top box, a handheld computer, a personal digital assistant, a personal and portable audio device, a cellular telephone, or other processing device.

The memory 130 may be any machine-readable media technology, such as Random Access Memory (RAM), Dynamic RAM (DRAM), Read-Only Memory (ROM), flash, cache, and so on. Memory 130 may store instructions and/or data represented by data signals that may be executed by a processor of the computer system 128 (processor not shown). The instructions and/or data may comprise software for performing techniques of the present invention. Memory 130 may also contain additional software and/or data (not shown).

In one embodiment, computer system 128 may also comprise a machine-readable storage media 110 which operates to store instructions and data in a manner similar to memory 130, but typically comprises higher capacity and slower access speeds than does memory 130. Exemplary storage media 110 include hard drives, compact disks, digital video disks, flash memory, and so on.

Storage media 110 may comprise an audio file 132 having audio content 118 and meta-data 120. Of course, the meta-data 120 may be stored in a separate file from the audio content 118 as well. Memory 130 comprises text-to-speech software 112 which operates to convert textual formatted data into digital audio formatted data. Memory 130 may further comprise software 114 to concatenate an audio title to the audio content 118 in response to an operation to transfer the audio file 132 to a second computer system 134.

The second computer system 134 may comprise a memory 124 and, in some embodiments, further comprise a machine-readable storage media 102. Refer to the description of computer system 128, comprising memory 130 and storage media 110, for details about exemplary memory and storage media. Computer system 134 may comprise a speaker 106 for rendering audio content. Of course, both computer systems 134 and 128 may comprise many additional hardware and software components not shown, so as not to obscure the discussion of the present invention.

A coupling 108 may exist between the computer systems 134 and 128. When coupling a personal computer or other device to a portable audio player device, the coupling 108 may comprise a signaling cable, such as a serial or parallel bus cable, or a wireless infrared or high-frequency radio link, among numerous possibilities. When coupling a personal computer system, portable audio player, or other device to a computer system of a network, the coupling 108 may comprise various networking technologies such as network interface hardware, modems, routers, bridges, phone lines, and so on. A network may be any collection of interconnected devices capable of transporting digital content between one another. For example, a network may be a local area network (LAN), a wide area network (WAN), the Internet, a terrestrial broadcast network such as a satellite communications network, or a wireless network.

The computer systems 134 and 128 may cooperate to transmit (transfer) the audio file 132 from the first system 128 to the second system 134. Initiating said transfer may result in the first computer system 128 operating to provide title text 138 of the file meta-data 120 to the TTS software 112. TTS software 112 may operate to convert the title text to an audio format. For example, if the title text comprises “Stairway to Heaven by Led Zepplin”, the TTS software 112 may operate to convert this text to an audio title which, when rendered by a speaker, bears a reasonable facsimile to the spoken words “Stairway to Heaven by Led Zepplin”. This audio title 138 may be provided to software 114, which operates to concatenate the audio title 138 to the audio content 118, to produce a new file 136. This new file 136 (which in some embodiments may exist only as signals in memory 130), may be transferred to the second computer system 134 via coupling 108.

In one embodiment, some or all of the operations to generate and concatenate the audio title may be performed prior to initiation of the transfer. In one embodiment, all or a portion of the audio title 138 may be concatenated to the audio content 118 after the audio content 118. In one embodiment, a portion of the audio title 138 may be concatenated before the audio content 118, and a portion concatenated after. In one embodiment, substantially of the acts previously described may be performed, except that instead of concatenating all of the audio title 138, at least a portion of the audio title 138 may be mixed or blended with the audio content 118 as a “voice over” or “lead in”. All or portions of the signals of the audio content 118 and audio title 138 may be mixed to produce said “voice over” or “lead in” effect. Both the audio title 138 and audio content 118 may be rendered simultaneously, where the audio content 118 may be somewhat attenuated during the voice over of the audio title 138.

Second computer system 134 may receive file 136 including concatenated audio title 138 and store said file 136 on storage media 102 as file 138. File 138 may be one of several audio files stored thereon. When the user of computer system 134 wishes to browse the stored files and possibly select one for play, such browsing may be accomplished by rendering the first few seconds of the audio of the files, said first few seconds comprising the audio title 138. By simply listening, the user may determine the nature of the content of an audio file 138.

File 138 may be rendered by providing file 138 to a player function 108 comprised by memory. Player function 108 may be implemented as logic for decoding and sequencing audio data, as well as interpreting meta-data 120 of file 138 relevant to rendering (such as sampling rate). Player function 108 may be implemented as software, hardware, firmware, or any combination thereof.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features were omitted or simplified in order not to obscure the present invention.

Although some operations of the present invention (for example, TTS) are described in terms of a particular embodiment, embodiments of the present invention may be implemented in hardware or software or firmware, or a combination thereof. Embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system embodying the playback device components includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a removable storage media or device (e.g., floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

FIG. 2 shows an embodiment 120 of meta-data in accordance with the present invention. Meta-data 120 may, in one embodiment, comprise a tagged format. Thus, items of the meta-data such as title, description, and so on, may be identified using data fields known as tags. The tags facilitate parsing and interpretation of the meta-data 120. Title tag 208 identifies item 202 which follows as a song title. Description tag 210 identifies item 204 which follows as a song description. Bibliographic tag 212 identifies item 206 which follows as bibliographic information. Of course the meta-data 120 may contain additional information as well. Some or all of title 202, description 204, and bibliographic information 206 may be stored in a text format or other format which is not audio. In accordance with the present invention, some or all of title 202, description 204, and bibliographic information 206, or other descriptive meta-data, may be read and converted to audio, then concatenated with the audio file. In one embodiment, some or all of title 202, description 204, and bibliographic information 206, or other descriptive meta-data may be stored in an audio format. In this case the descriptive meta-data may be read and concatenated without resort to conversion of the descriptive data from text or some other format to audio.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method comprising:
reading descriptive information about an audio file from meta-data for the audio file; and
concatenating at least a portion of an audio format of the descriptive information to the audio file.

2. The method of claim 1 further comprising:
converting the descriptive information to the audio format prior to concatenating.

3. The method of claim 1 wherein at least a portion of the audio format of the descriptive information is concatenated to the beginning of the audio file.

4. The method of claim 1 wherein the concatenating is performed in response to an operation to transfer the audio file from a first computer system to a second computer system.

5. The method of claim 1 wherein the audio file comprises the meta-data.

6. A method comprising:
reading descriptive information about an audio file from meta-data for the audio file; and
mixing an audio format of at least a portion of the descriptive information with the audio file.

7. The method of claim 6 further comprising:
converting the descriptive information to the audio format prior to mixing.

8. The method of claim 6 wherein at least a portion of the audio format of the descriptive information is mixed with audio at the beginning of the audio file.

9. The method of claim 6 wherein the mixing is performed in response to an operation to transfer the audio file from a first computer system to a second computer system.

10. The method of claim 6 wherein the audio file comprises the meta-data.

11. An article comprising:
a machine-readable media comprising instructions which, when executed by a processor, result in;
reading descriptive information about an audio file from meta-data for the audio file; and
concatenating at least a portion of an audio format of the descriptive information to the audio file.

12. The article of claim 11 further comprising instructions which, when executed by the processor, further result in:
converting the descriptive information to the audio format prior to concatenating.

13. The article of claim 11 wherein concatenating further comprises:
concatenating at least a portion of the audio format of the descriptive information to the beginning of the audio file.

14. The article of claim 11 wherein the concatenating is performed in response to an operation to transfer the audio file from a first computer system to a second computer system.

15. The article of claim 11 wherein the audio file comprises the meta-data.

16. A system comprising:
a processor; and
a machine-readable media comprising instructions which, when executed by the processor, result in;
reading descriptive information about an audio file from meta-data for the audio file; and
concatenating at least a portion of an audio format of the descriptive information to the audio file.

17. The system of claim 16 further comprising instructions which, when executed by the processor, further result in:
converting the descriptive information to the audio format prior to concatenating.

18. The system of claim 16 wherein concatenating further comprises: concatenating at least a portion of the audio format of the descriptive information to the beginning of the audio file.

19. The system of claim 16 wherein the concatenating is performed in response to an operation to transfer the audio file from a first computer system to a second computer system.

20. The system of claim 16 wherein the audio file comprises the meta-data.
